(19) United States
(12) Patent Application Publication
(10) Pub. No.: US 2014/0081745 A1
(43) Pub. Date: Mar. 20, 2014

(54) METHOD AND SYSTEM FOR CURBING COUPON DISTRIBUTION DUE TO RISK PROFILE

(71) Applicant: Alan COOKE, Dublin (IE)

(72) Inventor: Alan COOKE, Dublin (IE)

(73) Assignee: MASTERCARD INTERNATIONAL INCORPORATED, Purchase, NY (US)

(21) Appl. No.: 13/622,775

(22) Filed: Sep. 19, 2012

(51) Int. Cl. G06Q 30/02

(52) U.S. Cl. 705/14.49

(57) ABSTRACT

A method for limiting coupon distribution based on risk includes: storing consumer profiles, each including an identifier; receiving data for transactions involving a consumer; receiving credit information for the consumer; generating variables to identify patterns of behavior based on the data; creating a behavioral profile for the consumer based on the variables; analyzing the credit information and the behavioral profile to determine a risk profile; and distributing coupons to the consumer based on the consumer's risk profile. Another method includes: storing coupons, each including a coupon identifier and a propensity to spend beyond acceptable levels threshold; storing consumer profiles, each including a consumer identifier; receiving a propensity to spend beyond acceptable levels for a consumer; identifying a consumer profile for the consumer; and distributing a coupon to the consumer, wherein the consumer's indicator of propensity to spend beyond acceptable levels does not exceed the coupon's propensity to spend beyond acceptable levels threshold.

### FIELD

The present disclosure relates to a technical solution in the form of a system and method for the limiting of distribution of coupons to consumers based on risk, specifically limiting coupon distribution to consumers based on a real-time evaluation of a risk profile based on transactional data and credit information.

### BACKGROUND

In order to increase revenue and obtain returning consumers, many merchants and manufacturers issue coupons, deals, and offers to consumers. The coupons may allow for savings by the consumer, while at the same time resulting in additional revenue to the merchant as a result of the purchase, and in instances where the consumer may purchase additional items separate from the coupon or deal.

However, some consumers may have a tendency to make a purchase spontaneously or primarily based on a coupon or deal, such that they would not have purchased the product or service absent the coupon or deal. In instances where a consumer is in a disadvantageous financial position or a compulsive disorder, for instance, this may result in problems for both parties to the transaction and perhaps third parties, such as credit issuers. Consumers may inadvertently spend beyond acceptable levels and even beyond their means, which can result in significant financial trouble for the consumers. This may also result in an adverse effect on the merchant or manufacturer or third parties, due perhaps to potential loss of a loyal consumer and repeat business due, or due to collection efforts. Also, many businesses are socially conscience and desire not to create or exacerbate societal problems.

Thus, there is a need for a technical solution to curb or mitigate potential problems related to consumers spending beyond acceptable levels by virtue of receiving a coupon or deal.

### SUMMARY

The present disclosure provides a description of a systems and methods for limiting the distribution of coupons to consumers based on risk profiles.

A method for limiting coupon distribution based on risk includes: storing, in a database, a plurality of consumer profiles, wherein each consumer profile of the plurality of consumer profiles corresponds to a consumer and includes a consumer identifier; receiving, by a receiving device, transaction data for a plurality of financial transactions involving the consumer; receiving, by the receiving device, credit information associated with the consumer; generating, by a processing device, account-level variables to identify patterns of behavior based on the received transaction data and creating a real-time behavioral profile associated with the consumer based on the account-level variables; analyzing the received credit information and the real-time behavioral profile to determine a risk profile of the consumer; storing, in the consumer profile associated with the consumer, the determined risk profile; and distributing coupons to the consumer based on the determined risk profile associated with the consumer.

A method for distributing coupons based on risk includes: storing, in a coupon database, a plurality of coupons, wherein each coupon includes at least a coupon identifier and a threshold indicative of a propensity to spend beyond acceptable levels; storing, in a consumer database, a plurality of consumer profiles, wherein each consumer profile is associated with a consumer and includes at least a consumer identifier and a method of distribution; receiving, by a receiving device, an indicator of propensity to spend beyond acceptable levels for a specified consumer; identifying, in the consumer database, a consumer profile associated with the specified consumer; and distributing, by the method of distribution corresponding to the identified consumer profile, at least one coupon stored in the coupon database to the specified consumer, wherein the received indicator of a propensity to spend beyond acceptable levels for the specified consumer does not exceed the corresponding threshold for each coupon of the at least one coupon distributed to the specified consumer.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for the limiting of the distribution of coupons based on consumer risk in accordance with exemplary embodiments.

FIG. 2 is a block diagram illustrating a processing server for use in the system of FIG. 1 in accordance with exemplary embodiments.

FIG. 3 is a block diagram illustrating a consumer database of the processing server of FIG. 2 in accordance with exemplary embodiments.

FIG. 4 is a block diagram illustrating a coupon database of the processing server of FIG. 2 in accordance with exemplary embodiments.

FIG. 5 is a flow chart illustrating a method for creating transaction based risk scores in accordance with exemplary embodiments.

FIG. 6 is a block diagram illustrating system architecture of a computer system in accordance with exemplary embodiments.

FIG. 7 is a flow chart illustrating an exemplary method for limiting coupon distribution based on risk in accordance with exemplary embodiments.

FIG. 8 is a flow chart illustrating an exemplary method for distributing coupons based on risk in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Limiting Coupon Distribution Based on Consumer Risk

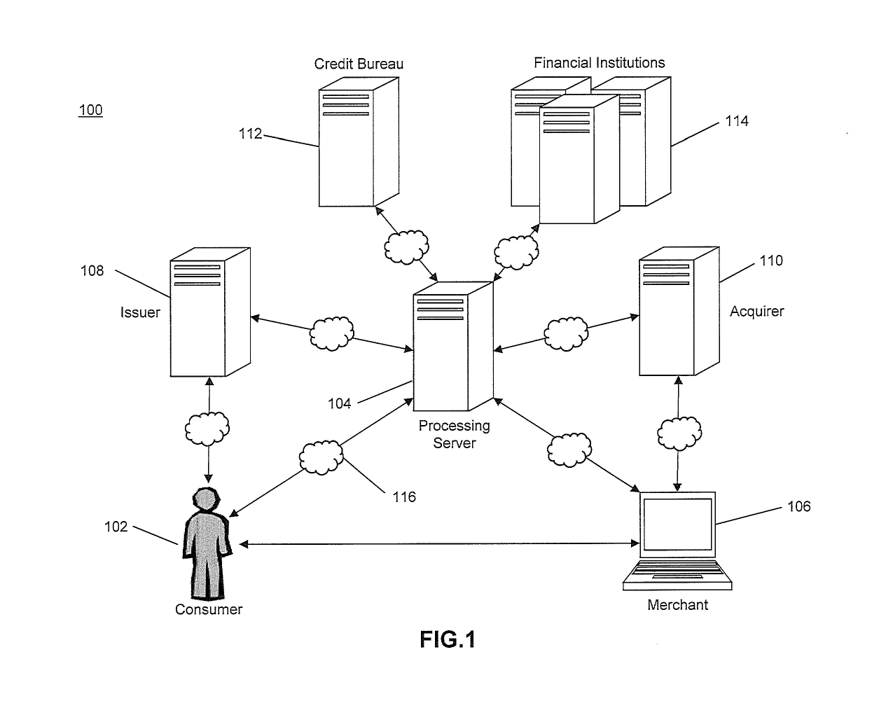

FIG. 1 is a block diagram illustrating a system 100 for limiting the distribution of coupons to consumers based on consumer risk profiles.

The system 100 may include a consumer 102 and a merchant 106. The consumer 102 and the merchant 106 may engage in a financial transaction, such as a transaction for the purchase of goods or services. In some embodiments, the consumer 102 may be at a physical location of the merchant 106 (e.g., at a merchant point-of-sale). In other embodiments, the consumer 102 may engage in a transaction with the merchant 106 through a network 116 (e.g., such as via the Internet, telephone, e-mail, or other “card-not-present” transactions). The network 116 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

The consumer 102 may choose to use a payment card (e.g., credit card, debit card, etc.) to pay for a financial transaction conducted with the merchant 106. The payment card used by the consumer 102 may be issued to the consumer 102 by an issuer 108, such as an issuing bank or other financial institution. The issuer 108 and/or consumer 102 may set a limit (e.g., a credit limit, a transaction limit, a spending limit, spending rate, etc.) for the payment card during its life or when the payment card is issued to the consumer 102, or the payment card may be a no preset spending limit payment card.

The merchant 106 may accept the payment card for payment of the financial transaction. The merchant 106 may then process the payment card (e.g., at a point-of-sale system) and transmit transaction details to an acquirer 110. The acquirer 110 may be an acquiring bank or other financial institution that operates for or on behalf of the merchant 106 for the purposes of processing payment card transactions and communicating with the issuer 108. The transaction details may be provided in an authorization request, which may originate at the merchant 106 or the acquirer 110.

A processing server 104 may be configured to communicate with both the issuer 108 and the acquirer 110 to process a payment card transaction between the consumer 102 and the merchant 106. Communication methods between the processing server 104 and other entities will be apparent to persons having skill in the relevant art. The processing server 104 may receive an authorization request from the acquirer 110 or the merchant 106. The authorization request may include, for example, payment card information, consumer details, or transaction details, such as the amount of the transaction. The processing server 104 may communicate with the issuer 108 to receive a determination if the financial transaction should be allowed or declined. The processing server 104 may notify the acquirer 110 or the merchant 106 of the allowing or declining of the transaction by responding to the authorization request. The merchant 106 may then finalize the transaction with the consumer 102 (e.g., by furnishing the transacted—for goods or services). It will be apparent to persons having skill in the relevant art that the processing of payment card transactions as discussed herein may be performed by a separate entity, such as a dedicated financial transaction processing agency (e.g., MasterCard®, VISA®, etc.), with the processing server 104 configured to receive transaction information from such an entity or be part of such an entity.

The processing server 104 may be configured to distribute coupons (e.g., deals, offers, etc.) to the consumer 102. In an exemplary embodiment, the processing server 104 may distribute coupons to the consumer 102 based on an assessment of the risk profile of the consumer 102. The risk profile of the consumer 102, discussed in more detail below, may include an evaluation of the propensity of the consumer 102 to spend beyond their means. The evaluation may be based on a behavioral profile, account-level variables, and transaction scoring data, discussed in more detail below. The processing server 104 may perform the evaluation based on information obtained from a credit bureau 112 or from financial institutions 114 (e.g., banks, credit unions, etc.).

### Processing Server

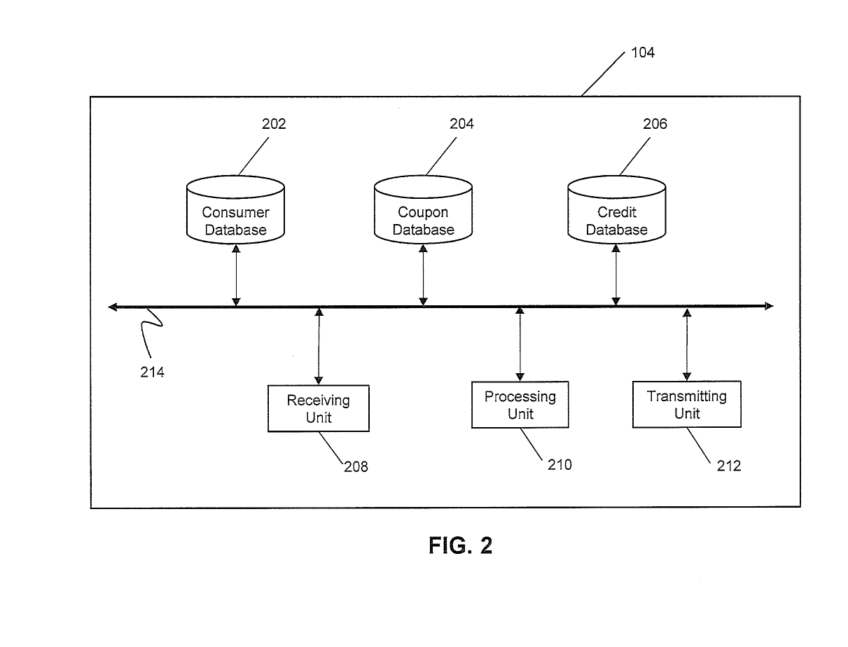

FIG. 2 illustrates an embodiment of the processing server 104. The processing server 104 may include a consumer database 202, a coupon database 204, a credit database 206, a receiving unit 208, a processing unit 210, and a transmitting unit 212. Each of the components may be connected via a bus 214. Suitable types and configurations of the bus 214 will be apparent to persons having skill in the relevant art.

Data stored in the consumer database 202, the coupon database 204, and the credit database 206 (the “databases”) may be stored on any type of suitable computer readable media, such as optical storage (e.g., a compact disc, digital versatile disc, blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 116).

The consumer database 202, discussed in more detail below, may be configured to store a plurality of consumer profiles. Each consumer profile may be associated with a consumer, such as the consumer 102. A risk profile for the corresponding consumer 102 may be stored in the respective consumer profile in the consumer database 202. The coupon database 204, also discussed in more detail below, may be configured to store a plurality of coupons for distribution to consumers, such as the consumer 102. Each coupon in the coupon database 204 may be a coupon, offer, discount, deal, etc. for products (e.g., goods, services, etc.) of gift or nearly any other economic benefit that encourages a desired consumer behavior that comes from a merchant (e.g., the merchant 106), manufacturer, retailer, etc. perhaps via a daily-deal or other coupon distributor Suitable types of coupons will be apparent to persons having skill in the relevant art.

The credit database 206 may be configured to store credit information associated with a plurality of consumers, such as the consumer 102. The receiving unit 208 may be configured to receive credit information from a third party, such as the credit bureau 112. Credit information received by the receiving unit 208 and stored in the credit database 206 may include current credit limits, past credit limits, spending limits, lines of open credit, credit scores, etc. Other credit information that may be included in the credit database 206 for use in the methods as discussed herein will be apparent to persons having skill in the relevant art.

The receiving unit 208 may be further configured to receive transaction data for a plurality of financial transactions involving the consumer 102. In some embodiments, the processing server 104 may further include a database for storage of the transaction data. In other embodiments, the transaction data may be stored in the consumer database 202 in consumer profiles associated with the respective consumers. The transaction data may be received from one or more financial institutions or payment card processors, and in one embodiment at least two financial institutions 114.

The transaction data may include data for a plurality of financial transactions associated with or involving the consumer 102 utilizing a plurality of payment cards or other sources (e.g., debit cards, checks, cash transactions, wire transfers, etc.). Types of transaction data suitable for performing the functions disclosed herein will be apparent to persons having skill in the relevant art. Example transaction data may include date and time of transaction, transaction identification numbers, physical or geographical location of the transaction, merchant information (e.g., location, industry, merchant identification number (MID), etc.), method of payment, channel, transaction type, transaction flags, amount of the transaction, etc.

The receiving unit 208 may also be configured to receive an indicator of propensity to spend beyond one or more acceptable levels (e.g., total spending, spending in particular categories, such as food, entertainment, various hobbies, etc.) and including spending beyond one's means for a specific consumer, such as the consumer 102. The indicator of propensity to spend beyond acceptable levels may be an indication that the consumer 102 may spend beyond one or more acceptable limits including spending beyond their means such that if receiving a coupon, the consumer 102 may engage in a financial transaction using that coupon to their detriment by spending more than they should or have by virtue of the resulting financial transaction. In some embodiments, the indication of propensity to spend beyond acceptable levels may be supplied by a system, such as described below that tends to indicate a propensity to spend beyond one or more acceptable levels, stored in the associated consumer profile in the consumer database 202.

The processing unit 210 may be configured to generate account-level variables to identify patterns of behavior based on the transaction data to create a real-time behavioral profile associated with each consumer 102. The generation of account-level variables is discussed in more detail below. The processing unit 210 may also be configured to analyze the received credit information along with the real-time behavioral profile to determine a risk profile of the consumer 102. In some embodiments, the processing unit 210 may be configured to store the determined risk profile in the consumer database 202 (e.g., in the respective consumer profile).

The transmitting unit 212 may be configured to transmit (e.g., distribute, send, etc.) coupons to each consumer 102 in the consumer database 202 based on the determined risk profile. In some embodiments, the transmitting unit 212 may distribute coupons to a consumer 102 only if a propensity to spend beyond acceptable levels associated with the consumer 102 is within a propensity to spend beyond acceptable levels threshold for the respective coupon. In other embodiments, the transmitting unit 212 may only distribute coupons to a consumer 102 if the consumer 102 is indicated with a predetermined propensity to spend beyond acceptable levels value.

As illustrated in FIG. 1, the processing server 104 also processes the financial account transaction, and elements used therein are not illustrated in that they may be conventional. It should also be noted that the processing server 104 is shown as a single entity, such as a server farm controlled by a financial transaction processor, but the coupon distribution functions described herein can be provided by one entity and the financial transaction processing can be provided by a separate entity or third party with communication between the two, depending on implementation details.

### Consumer Database

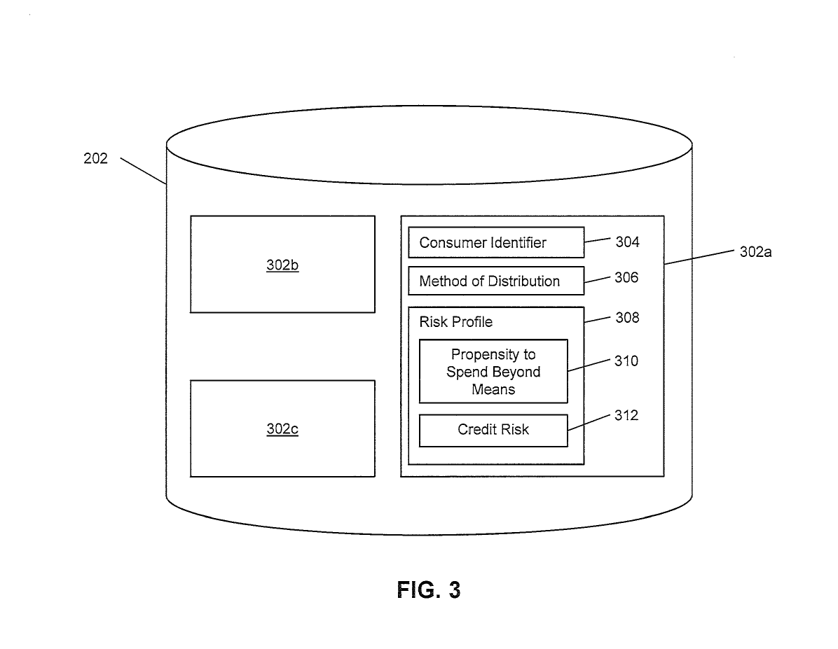

FIG. 3 is an illustration of the consumer database 202 of the processing server 104 to be used in the system 100 of FIG. 1.

The consumer database 202 may include a plurality of consumer profiles 302, illustrated in FIG. 3 as consumer profile 302a, consumer profile 302b, and consumer profile 302c, though of course it is envisioned there would be many more. Each consumer profile 302 may include a consumer identifier 304, a method of distribution 306, and a risk profile 308. The consumer identifier 304 may be a unique value associated with a consumer 102 for the purposes of identifying the consumer 102 and/or the corresponding consumer profile 302. Values suitable for use as the consumer identifier 304 will be apparent to persons having skill in the relevant art and may include a financial account number (e.g., payment card number, checking account number, etc.), phone number, e-mail address, personal identification number (PIN), unique number generated or identified by the processing server 104, etc.

The method of distribution 306 may be a preferred method for the distribution of coupons to the consumer 102 as determined by the consumer 102. In some embodiments, methods for distribution 306 may include multiple preferred methods for distribution. Methods of distribution 306 may include traditional mail, e-mail, short message service (SMS) message, notifications via an application program (app) on a mobile communication device or other device capable of receiving and displaying information, or nearly any other communication channel available to the consumer 102. In some instances, a consumer 102 may indicate a different preferred method of distribution for multiple instances based on a variety of factors. For example, a consumer 102 may indicate a different method of distribution for different types of coupons (e.g., percentage off, value off, buy one get one free), different merchants or retailers, different values (e.g., 5% off, 10% off, 25% off, etc.), different industries (e.g., personal services, electronic, etc.), different expirations (e.g., one week, one month, no expiration, etc.), different personal interests or consumer defined or predefined categories, different times or geographic locations, or nearly any combination thereof.

The risk profile 308 may be a profile of the risk of the associated consumer 102 based on a generated real-time behavioral profile and credit information, as discussed in more detail below. The risk profile 308 may include a propensity to spend beyond acceptable levels 310 and a credit risk 312. The credit risk 312 may be a determination of the credit risk of the consumer 102, such as based off of the credit information received by the receiving unit 208 and optionally stored in the credit database 206. Valuations and representations of credit risk of a consumer will be apparent to persons having skill in the relevant art.

The propensity to spend beyond acceptable levels 310 may be an indication of the likelihood of the consumer 102 to spend beyond their means or just more than they should. In some instances, the propensity to spend beyond acceptable levels 310 may be a propensity to spend when receiving a coupon such as might occur for people who have relatively uncontrolled spontaneous or compulsive behavior, or may be a propensity to spend beyond acceptable levels generally. In some embodiments, each consumer profile 302 may include multiple propensities to spend beyond means 310, such as a different propensity for different merchants, coupon values, industries, etc. Different propensities that may be included will be apparent to persons having skill in the relevant art.

### Coupon Database

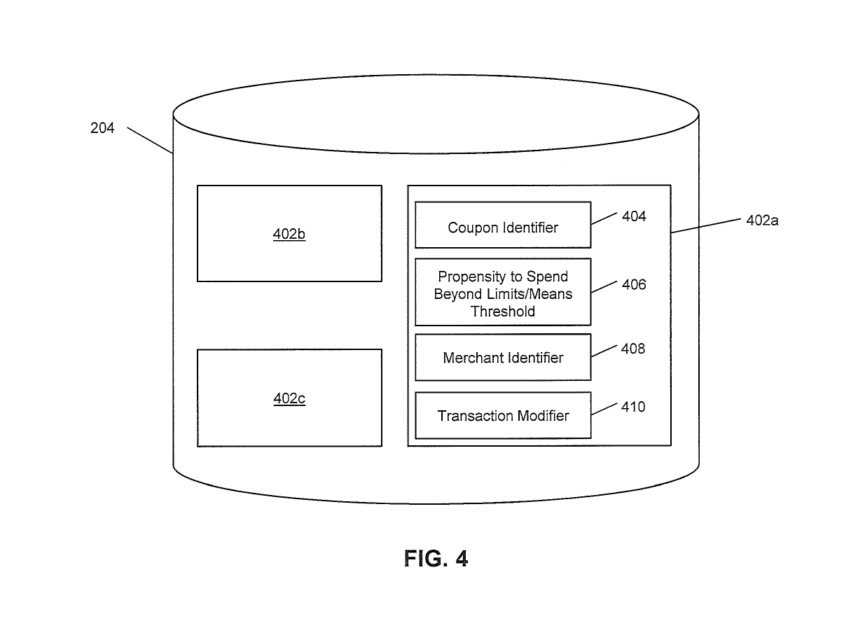

FIG. 4 is an illustration of the coupon database 204 of the processing server 104 of the system 100 illustrated in FIG. 1.

The coupon database 204 may include a plurality of coupons 402, illustrated in FIG. 4 as coupon 402a, coupon 402b, and coupon 402c, though of course a commercial embodiment would have many more. Each coupon 402 may include at least a coupon identifier 404, a threshold identifying a propensity to spend beyond acceptable levels 406, merchant identifier 408, and transaction modifier 410. The coupon identifier 404 may be a unique value associated with the coupon 402, such as for identification by the consumer 102 or the merchant 106 (e.g., during a purchase). Suitable identifiers used as the coupon identifier 404 may include a universal product code (UPC), serial number, stock-keeping unit (SKU), or other type of unique value, such as one generated or identified by the processing server 104, as will be apparent to persons having skill in the relevant art. In some embodiments, the coupon 402 may also include a consumer identification, which may correspond to the consumer identifier 304 to associate the coupon 402 with a particular consumer 102 for analytical review of the customer's interests.

The propensity to spend beyond acceptable levels threshold 406 may be an indication of when the coupon 402 may be distributed or withheld from a consumer, based on the consumer's corresponding propensity to spend beyond acceptable levels 310. For example, if the consumer's propensity to spend beyond acceptable levels 310 is beyond the propensity to spend beyond acceptable levels threshold 406, then the coupon 402 may not be distributed to the corresponding consumer 102. If, on the other hand, the consumer's propensity to spend beyond acceptable levels 310 is within the threshold, then the coupon 402 may be distributed to the consumer 102. The threshold 406 (and/or risk profile) may be set by analytics, as described below, or by caregivers, parents, other authorities or even the customer 102.

The transaction modifier 410 may indicate how a financial transaction may be modified by the corresponding coupon 402 (e.g., 10% off, $5 off, buy one get one free, etc.). In some embodiments, a coupon 402 may further include at least one transaction requirement. The transaction requirement may indicate specific transaction details that must be met in order for the coupon 402 to be valid for the transaction. Suitable transaction requirements will be apparent to persons having skill in the relevant art, such as minimum transaction amount, specific merchant or merchants, minimum quantity, expiration date, etc.

### Transaction Scoring

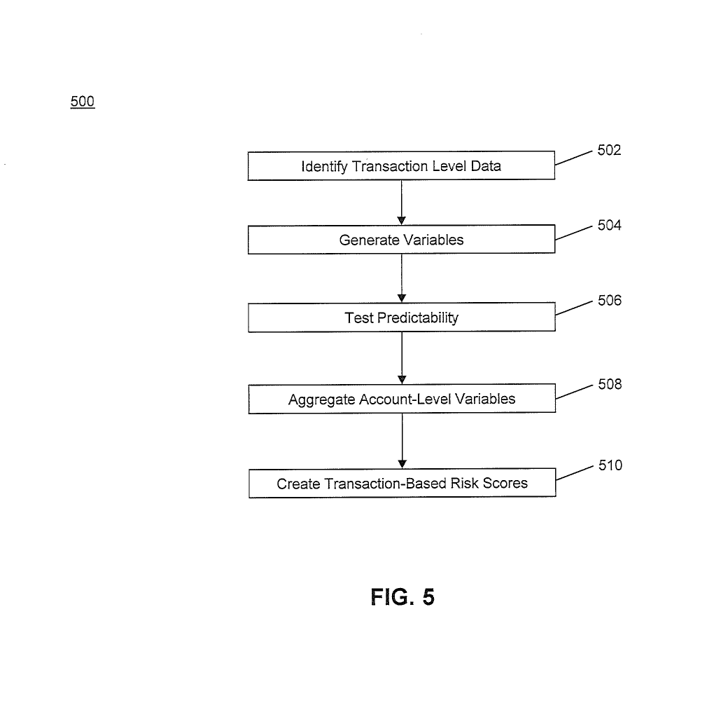

FIG. 5 illustrates a method 500 for creating transaction-based risk scores, which may be used (e.g., by the processing server 104) in the real-time evaluation of a risk profile for a consumer (e.g., the consumer 102), such as for use in a determination of the distribution of coupons.

In step 502, the processing server 104 (e.g., the processing unit 210) may identify transaction level data corresponding to the consumer 102. The transaction level data may be obtained (e.g., received by the receiving unit 208) from at least two financial institutions 114. In some embodiments, the processing server 104 may collect transaction level data as part of processing financial transactions as a financial transaction processing agency. In an exemplary embodiment, the consumer 102 may provide consent to the processing server 104 in order to obtain and/or collect the transaction level data.

The transaction level data may include data for a plurality of transaction associated with the consumer 102 utilizing a plurality of payment cards or other sources, such as debit cards, checks, cash transactions, wire transfers, etc. Types of transaction level data suitable for performing the functions as disclosed herein will be apparent to persons having skill in the relevant art.

The processing server 104 may identify appropriate combinations of transaction characteristics. For example, the processing server 104 may combine transaction data for all transactions with a common merchant or merchant industry, or may group transactions based on location, transaction amount, or any other suitable information or combination thereof. In step 204, the processing server 110 may generate variables. Variables generated may be any type of variable suitable for performing the functions as disclosed herein. For example, variables may be generated from the transaction data to identify patterns of fraud, to identify high-risk transactions, to identify low-risk transactions, or to identify the likelihood that the consumer 102 will pay off a specific transaction. In an exemplary embodiment, the processing server 104 may generate variables to identify the propensity of the consumer 102 to spend beyond their means. It should be noted that the processing server 104 can be separated into two entities, one for generating the risk profile, such as a different division of one entity or a third party, and the other for coupon distribution. A further iteration is that the financial transaction processing can also be separated out such that each of the three discrete functions is stand alone or combined in any desirable permutation. In a further embodiment, the processing server 104 may generate multiple variables to identify the propensity of the consumer 102 to spend beyond acceptable levels for multiple categories, such as merchants, transaction amounts, merchandise types, and industries, etc. In some embodiments, the processing unit 210 may store the generated variables as the propensity to spend beyond acceptable levels 310 in the corresponding consumer profile 302.

In step 206, the processing server 104 may test the predictability of the generated variables. For example, if the processing server 104 generates variables for identifying the propensity for the consumer 102 to spend beyond their means, the predictability of the variables may be tested against the transaction data obtained for the consumer 102. Testing the predictability of variables may provide the processing server 104 with information regarding the accuracy of the variables, or information regarding false-positives or other useful information.

As will be apparent to persons having skill in the relevant art, this step may be performed on transaction data not included in the generation of variables, or on only a subset or sample of the obtained transaction data. Similarly, the generation of variables may be performed by utilizing only a subset or sample of the obtained transactions data. If the generation of variables is performed utilizing a subset of the transaction data, then the predictability testing of the generated variables may be performed on a different subset of the obtained transaction data. Methods and systems for testing the predictability of the generated variables on transaction data will be apparent to persons having skill in the relevant art.

In step 208, account-level variables may be aggregated by the processing server 104. Account-level variables may be used to capture all transaction dimensions at industry and merchant levels. Exemplary account-level variables may include recency, frequency, monetary, velocity, acceleration, smoothed time series, target weighted roll-ups, and consumer activities. The account-level variables may be indicative of consumer behavior and identify patterns of behavior for the consumer 102 in real-time. For example, the frequency account-level variable may provide an indication of how often the consumer 102 engages in a financial transaction at a particular merchant (e.g., a mobile phone carrier) or in a particular industry (e.g., public transportation).

The account-level variables may be used, in step 210, in the creation of transaction-based risk scores. Transaction scores may be representations of the credit risk of an individual transaction by utilizing real-time transaction data and aggregated account-level variables, which may increase the predictive accuracy of risk management. The use of real-time transaction data as opposed to traditional credit reporting data, which is not obtained in real-time, may result in increased accuracy and can provide additional benefits to the consumer 102 or other parties (e.g., the issuer 108).

The individual scoring of transactions may allow the issuer 108 to finely segment their portfolios and more accurately and more quickly determine if an account (e.g., associated with the consumer 102) is risky or not. Furthermore, the processing server 104 may be able to use the transaction scoring to determine if a coupon distribution to the consumer 102 is risky or not. For example, transaction scoring may assist in the identification of coupon distributions that may seem risky, but instead are to good accounts that may provide merchants 106 and issuers 108 with future revenue. Alternatively, transaction scoring may notify the processing server 104 of potential spending beyond means problems faster than utilizing traditional credit reporting data, which may enable the processing server 104 to limit the distribution of coupons, which may in turn enable the consumer 102 and thereby the issuer 108 of encountering problems entirely. This may also result in the merchant 106 retaining a return customer in the consumer 102 that may otherwise be lost if the consumer 102 were to spend beyond their means due to the distribution of a coupon that could have been limited using risk profiling.

### Computer System Architecture

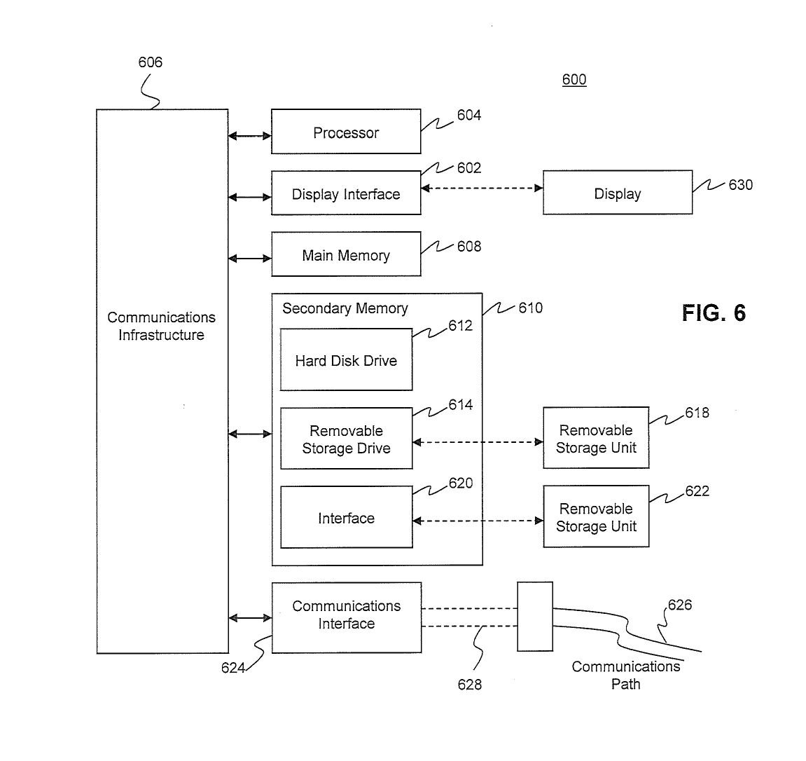

FIG. 6 illustrates a computer system 600 in which embodiments of the present disclosure, or portions thereof, may be implemented as computer-readable code. For example, the processing server 104, the merchant 106, the issuer 108, the acquirer 110, the credit bureau 112, and the financial institutions 114 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 5, 7, and 8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Processor device 604 may be a special purpose or a general purpose processor device. The processor device 604 may be connected to a communication infrastructure 606, such as a bus, message queue, network (e.g., the network 108), multi-core message-passing scheme, etc. The computer system 800 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive, the removable storage unit 618 may be a floppy disk. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

Computer program medium and computer usable medium may refer to memories, such as the main memory 608 and secondary memory 610, which may be memory semiconductors (e.g. DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 5, 7, and 8, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

### Exemplary Method for Limiting Coupon Distribution Based on Risk

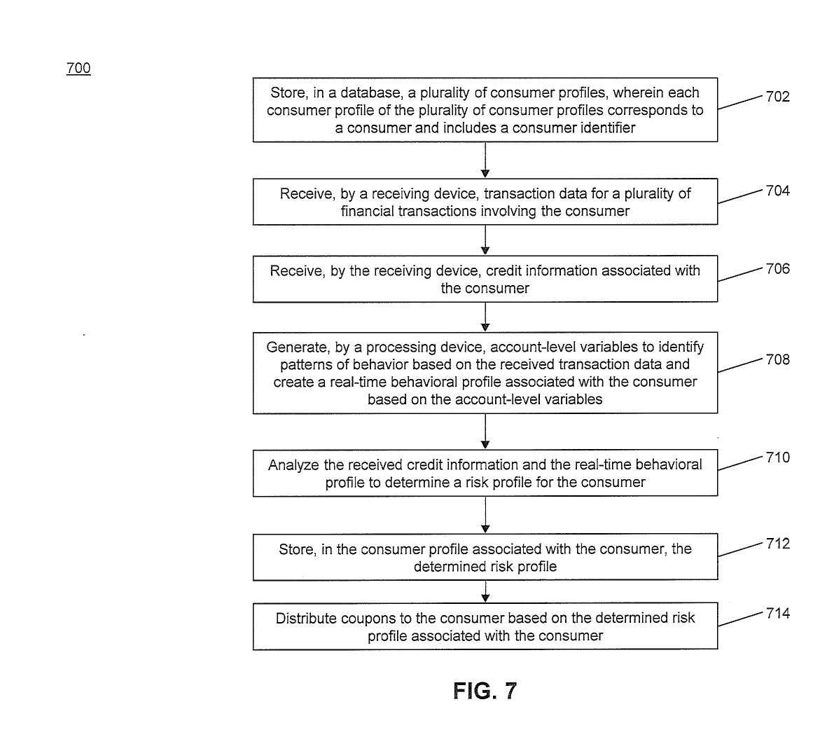

FIG. 7 illustrates a method 700 for the limiting of coupon distribution to a consumer (e.g., the consumer 102) based on risk.

In step 702, a plurality of consumer profiles (e.g., consumer profiles 302) may be stored in a database (e.g., the consumer database 202), wherein each consumer profile 302 of the plurality of consumer profiles corresponds to a consumer (e.g., the consumer 102) and includes a consumer identifier (e.g., the consumer identifier 304). In some embodiments, the consumer profile 302 may further include a method of distribution 306. In a further embodiment, the consumer profile 302 may include multiple methods of distribution, wherein each method of distribution 306 is associated with the distribution of coupons based on at least one factor. In yet a further embodiment, the at least one factor may include at least one of merchant, transaction amount, expiration date, industry, and coupon value, to provide some examples.

In step 704, transaction data for a plurality of financial transactions involving the consumer 102 may be received by a receiving device (e.g., the receiving unit 208). In one embodiment, the transaction data may be received from at least two financial institutions (e.g., the financial institutions 114). In a further embodiment, the at least two financial institutions 114 may include at least two issuers (e.g., such as the issuer 106) issuing a plurality of payment cards to the consumer 102. In another embodiment, the transaction data may include a plurality of financial transactions involving the consumer 102 and also involving a plurality of merchants (e.g., such as the merchant 106).

In step 706, the receiving unit 208 may receive credit information associated with the consumer 102 (e.g., from the credit bureau 112). In one embodiment, the receiving unit 208 may receive credit information from multiple credit bureaus. In some embodiments, the credit information may be stored in the credit database 206. In step 708, a processing device (e.g., the processing unit 210) may generate or receive account-level variables to identify patterns of behavior based on the received transaction data and create a real-time behavioral profile associated with the consumer 102 based on the account-level variables. In one embodiment, the account-level variables may include at least one of a propensity to spend and a propensity to spend beyond acceptable levels (e.g., the propensity to spend beyond acceptable levels 310). In embodiments where the transaction data may include transactions involving a plurality of merchants, the account-level variables may include a propensity to spend beyond acceptable levels for one or more merchants of the plurality of merchants.

In step 710, the received credit information and the created real-time behavioral profile may be analyzed (e.g., by the processing unit 210) to determine or receive a risk profile (e.g., the risk profile 308) for the consumer 102. In one embodiment, the risk profile 308 may include at least a propensity to spend beyond acceptable levels 310 and a credit risk 312. In step 712, the determined risk profile 308 may be stored in the consumer profile 302 associated with the consumer 102.

In step 714, coupons may be distributed to the consumer 102 based on the determined risk profile 308 associated with the consumer 102. In one embodiment, coupons may not be distributed to the consumer 102 if the risk profile 308 associated with the consumer 102 indicates a propensity to spend beyond certain levels, such as beyond their means. In embodiments where the transaction data includes a plurality of financial transactions involving a plurality of merchants, step 714 may include distributing only coupons associated with merchants of the plurality of merchants for which the risk profile 308 does not indicate a propensity to spend beyond acceptable levels 310 for the corresponding merchant.

However, the threshold for spending beyond means can be refined to represent a propensity to spend more than one should in response to coupons including special offers such as discounts, or gamification of the distribution of special offers. It could be set by the consumer, by the consumer' guardian or caregiver, a authoritative body, coupon distributors, merchants, manufactures, or nearly any other source of a measure or threshold measure that might be useful in the current system.

### Exemplary Method for Distributing Coupons Based on Risk

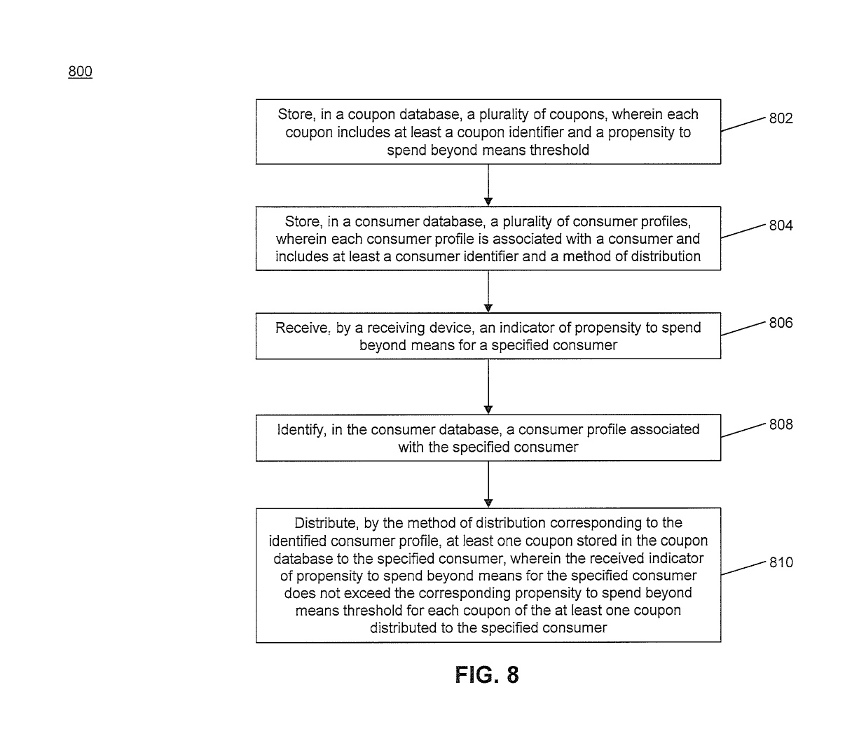

FIG. 8 illustrates a method 800 for the distribution of coupons to consumers based on risk.

In step 802, a plurality of coupons may be stored in a database (e.g., the coupon database 204), wherein each coupon (e.g., the coupon 402) may include at least a coupon identifier (e.g., the coupon identifier 404) and a propensity to spend beyond acceptable levels threshold (e.g., the propensity to spend beyond acceptable levels threshold 406), and the threshold can be refined to indicate a propensity to spend more than an acceptable amount in response to special offers and coupons. In some embodiments, each coupon 402 may further include a merchant identifier (e.g., the merchant identifier 408). In one embodiment, each coupon 402 may further include at least one of: a transaction modifier (e.g., the transaction modifier 408) and at least one transaction requirement.

In step 804, a plurality of consumer profiles may be stored in a consumer database (e.g., the consumer database 202), wherein each consumer profile (e.g., the consumer profile 302) is associated with a consumer and includes at least a consumer identifier (e.g., the consumer identifier 304) and a method of distribution (e.g., the method of distribution 306). In one embodiment, the method of distribution 306 may include multiple methods of distribution based on a plurality of factors.

In step 806, an indicator of propensity to spend beyond acceptable levels for a specified consumer (e.g., the consumer 102) may be received by a receiving device (e.g., the receiving unit 208). In embodiments where each coupon 402 may include the merchant identifier 408, the indicator of propensity to spend beyond acceptable levels may include the propensity to spend beyond acceptable levels at a specified merchant, wherein the specified merchant corresponds to at least one coupon 402 of the plurality of coupons. In one embodiment, the propensity to spend beyond acceptable levels may be based on at least credit information and transaction data associated with the specified consumer 102. In a further embodiment, the transaction data may be received from at least two financial institutions (e.g., the financial institutions 114). In an even further embodiment, the at least two financial institutions 114 may include at least two issuers (e.g., such as the issuer 108) issuing a plurality of payment cards to the specified consumer 102.

In another embodiment, the indicator of propensity to spend beyond acceptable levels for the specified consumer 102 may be based on at least transaction data associated with the specified consumer, wherein the transaction data includes a plurality of financial transactions involving a specified merchant (e.g., the merchant 106). In yet another embodiment, the indicator of propensity to spend beyond acceptable levels for the specified consumer 102 may be based on the analysis of credit information and a real-time behavioral profile associated with the specified consumer 102. In a further embodiment, the real-time behavioral profile may be created based on account-level variables associated with the specified consumer 102. In an even further embodiment, the account-level variables may identify patterns of behavior of the specified consumer 102 based on transaction data for a plurality of financial transactions involving the specified consumer 102.

In step 808, a consumer profile (e.g., the consumer profile 302) associated with the specified consumer 102 may be identified (e.g., by the processing unit 210) in the consumer database 202. In step 810, at least one coupon stored in the coupon database 204 may be distributed, by the method of distribution 306 corresponding to the identified consumer profile 302 to the specified consumer 102, wherein the received indicator of propensity to spend beyond acceptable levels for the specified consumer 102 does not exceed the corresponding propensity to spend beyond acceptable levels threshold 406 for each coupon 402 of the at least one coupon distributed to the specified consumer. In one embodiment, coupons may further be distributed if a propensity to spend beyond acceptable levels at a specified merchant 106 for the specified consumer 102 does not exceed the corresponding propensity to spend beyond acceptable levels threshold 406 for each coupon 402 of the at least one coupon where the specified merchant 106 is associated with the corresponding merchant identifier 408.

Techniques consistent with the present disclosure provide, among other features, systems and methods for curbing coupon distribution based on risk profiles. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for limiting coupon distribution based on risk, comprising:
storing, in a database, a plurality of consumer profiles, wherein each consumer profile of the plurality of consumer profiles corresponds to a consumer and includes a consumer identifier;
receiving, by a receiving device, transaction data for a plurality of financial transactions involving the consumer;
receiving, by the receiving device, credit information associated with the consumer;
generating, by a processing device, account-level variables to identify patterns of behavior based on the received transaction data and creating a real-time behavioral profile associated with the consumer based on the account-level variables;
analyzing the received credit information and the real-time behavioral profile to determine a risk profile of the consumer;
storing, in the consumer profile associated with the consumer, the determined risk profile; and
distributing coupons to the consumer based on the determined risk profile associated with the consumer.

2. The method of claim 1, wherein distributing coupons to the consumer includes not distributing any coupons if the risk profile associated with the consumer indicates a propensity to spend beyond an acceptable level.

3. The method of claim 1, wherein
the transaction data includes data for a plurality of financial transactions involving a plurality of merchants,
the account-level variables include propensity to spend beyond acceptable level for each merchant of the plurality of merchants, and
distributing coupons to the consumer includes distributing only coupons associated with merchants for which the determined risk profile does not indicate a propensity to spend beyond acceptable levels for the corresponding merchant.

4. The method of claim 1, wherein the transaction data is received from at least two financial institutions and wherein the at least two financial institutions include at least two issuers issuing a plurality of payment cards to the consumer.

5. The method of claim 1, wherein the account-level variables include at least one of a propensity to spend and a propensity to spend beyond at least one acceptable level.

6. A method of distributing coupons based on risk, comprising:
storing, in a coupon database, a plurality of coupons, wherein each coupon includes at least a coupon identifier and a propensity to spend beyond acceptable levels threshold;
storing, in a consumer database, a plurality of consumer profiles, wherein each consumer profile is associated with a consumer and includes at least a consumer identifier and a method of distribution;
receiving, by a receiving device, an indicator of propensity to spend beyond acceptable levels for a specified consumer;
identifying, in the consumer database, a consumer profile associated with the specified consumer; and
distributing, by the method of distribution corresponding to the identified consumer profile, at least one coupon stored in the coupon database to the specified consumer,
wherein the received indicator of propensity to spend beyond acceptable levels for the specified consumer does not exceed the corresponding propensity to spend beyond acceptable levels threshold for each coupon of the at least one coupon distributed to the specified consumer.

7. The method of claim 6, wherein
each coupon of the plurality of coupons further includes a merchant identifier,
the indicator of propensity to spend beyond acceptable levels includes the propensity to spend beyond acceptable levels at a specified merchant, and
the merchant identifier corresponding to the at least one coupon is associated with the specified merchant.

8. The method of claim 6, wherein the indicator of propensity to spend beyond acceptable levels for the specified consumer is based on at least credit information and transaction data associated with the specified consumer.

9. The method of claim 8, wherein the transaction data is received from at least two financial institutions and wherein the at least two financial institutions include at least two issuers issuing a plurality of payment cards to the specified consumer.

10. The method of claim 6, wherein the indicator of propensity to spend beyond acceptable levels for the specified consumer is based on at least transaction data associated with the specified consumer, wherein the transaction data includes a plurality of financial transactions including the specified merchant.

11. The method of claim 6, wherein the indicator of propensity to spend beyond acceptable levels for the specified consumer is based on the analysis of credit information and a real-time behavioral profile associated with the specified consumer.

12. The method of claim 11, wherein the real-time behavioral profile is created based on account-level variables associated with the specified consumer.

13. The method of claim 12, wherein the account-level variables identify patterns of behavior of the specified consumer based on transaction data for a plurality of financial transactions including the consumer.

14. A system for limiting coupon distribution based on risk, comprising:
a database configured to store a plurality of consumer profiles, wherein each consumer profile of the plurality of consumer profiles corresponds to a consumer and includes a consumer identifier;
a receiving device configured to receive transaction data for a plurality of financial transactions involving the consumer and credit information associated with the consumer; and
a processing device configured to
generate account-level variables to identify patterns of behavior based on the received transaction data,
create a real-time behavioral profile to determine a risk profile of the consumer,
store, in the consumer profile associated with the consumer, the determined risk profile, and
distribute coupons to the consumer based on the determined risk profile associated with the consumer.

15. The system of claim 14, wherein the processing device is further configured to not distribute coupons to the consumer if the risk profile associated with the consumer indicates a propensity to spend beyond their means.

16. The system of claim 14, wherein
the transaction data includes data for a plurality of financial transactions involving a plurality of merchants,
the account-level variables include propensity to spend beyond at least one acceptable level for each merchant of the plurality of merchants, and
the processing device is further configured to distribute only coupons associated with merchants for which the determined risk profile does not indicate a propensity to spend beyond acceptable levels for the corresponding merchant.

17. The system of claim 14, wherein the transaction data is received from at least two financial institutions and wherein the at least two financial institutions include at least two issuers issuing a plurality of payment cards to the consumer.

18. The system of claim 14, wherein the account-level variables include at least one of a propensity to spend and a propensity to spend beyond at least one acceptable level.

19. A system for distributing coupons based on risk, comprising:
a coupon database configured to store a plurality of coupons, wherein each coupon includes at least a coupon identifier and a propensity to spend beyond acceptable levels threshold;
a consumer database configured to store a plurality of consumer profiles, wherein each consumer profile is associated with a consumer and includes at least a consumer profile and a method of distribution;
a receiving device configured to receive an indicator of propensity to spend beyond acceptable levels for a specified consumer; and
a processing device configured to
identify a consumer profile associated with the specified consumer, and
distribute, by the method of distribution corresponding to the identified consumer profile, at least one coupon stored in the coupon database to the specified consumer,
wherein the received indicator of propensity to spend beyond acceptable levels for the specified consumer does not exceed the corresponding propensity to spend beyond acceptable levels threshold for each coupon of the at least one coupon distributed to the specified consumer.

20. The system of claim 19, wherein
each coupon of the plurality of coupons further includes a merchant identifier,
the indicator of propensity to spend beyond acceptable levels includes the propensity to spend beyond acceptable levels at a specified merchant, and
the merchant identifier corresponding to the at last one coupon is associated with the specified merchant.

21. The system of claim 19, wherein the indicator of propensity to spend beyond acceptable levels for the specified consumer is based on at least credit information and transaction data associated with the specified consumer.

22. The system of claim 21, wherein the transaction data is received from at least two financial institutions and wherein the at least two financial institutions include at least two issuers issuing a plurality of payment cards to the specified consumer.

23. The system of claim 19, wherein the indicator of propensity to spend beyond acceptable levels for the specified consumer is based on at least transaction data associated with the specified consumers, wherein the transaction data includes a plurality of financial transactions including the specified merchant.

24. The system of claim 19, wherein the indicator of propensity to spend beyond acceptable levels for the specified consumer is based on the analysis of credit information and a real-time behavioral profile associated with the specified consumer.

25. The system of claim 24, wherein the real-time behavioral profile is created based on account-level variables associated with the specified consumer.

26. The system of claim 25, wherein the account-level variables identify patterns of behavior of the specified consumer based on transaction data for a plurality of financial transactions including the consumer.
